(19) United States
(12) Patent Application Publication
(10) Pub. No.: US 2002/0038254 A1
(43) Pub. Date: Mar. 28, 2002

(54) Method and system of offering products as well as media which has recorded product offering programs

(76) Inventor: Soko Koike, Tokyo (JP)

Correspondence Address: BROWN PINNISI & MICHAELS, 400 M & T BANK BUILDING, 118 NORTH TIOGA ST, ITHACA, NY, 14850

(21) Appl. No.: 09/812,923

(22) Filed: Mar. 20, 2001

(30) Foreign Application Priority Data
Aug. 11, 2000 (JP) 2000-210047

(51) Int. Cl. G06F 17/60

(52) U.S. Cl. 705/26; 707/3

(57) ABSTRACT

A method of suggesting products to a person without requiring personal information on the person who desires to have products suggested has a purchase record storage mechanism 22b which stores information on 2 or more products which a purchaser has purchased previously, a search mechanism 21a which searches information for other products associated with one product that a purchaser or prospective purchaser has selected on this occasion from said purchase record storage mechanism 22b, an output mechanism 21b which offers said information on other products searched for by said search mechanism 21a to said purchaser or prospective purchaser on this occasion, whereby said information on products is the name or designation for a model or artist.

### BACKGROUND OF THE INVENTION

1. Field of the Invention

The present invention concerns a method and system of offering products as well as media which has recorded product offering programs, particularly a method and system of offering products which offers products which coincide with the preferences of individuals as well as media which has stored product offering programs.

2. Description of Related Art

The following sorts of things were used as methods of offering products which suited the preferences of individuals in the past. For example, there was a method in which individuals recorded their preferences for products in advance and then products which suited those preferences were searched and offered to them. Or individuals recorded their personal data in advance and products were offered to them using that personal data for the basis of a search. Japanese Unexamined Patent Application Hei 9-204445 is an example of the latter.

However, in these examples of prior art, data indicating a person's preferences or personal data of a person wishing to have products offered had to be recorded in advance and it was bothersome when the person would have to enter the data themselves. In addition there was a concern that, regardless of whether a person was entering the data himself or a person's personal preferences and personal data etc. were being collected without he or she being aware of it, such personal information might fall into the hands of unauthorized third parties.

### SUMMARY OF THE INVENTION

The present invention is for the purpose of improving on the problems of these examples of prior art, particularly to provide a method and system of offering products suitable to certain individuals without requiring the personal information of these individuals who desire products to be offered to them as well as media which has recorded programs offering products.

The inventor discovered from experience that when 2 or more differing products have been purchased according to the preferences of a certain person in the past (they may be things purchased at the same time or purchased at separate times) that there is a comparatively high probability that, according to another person who chose one of those products by his own preference, another product would appeal to that person. For example, they found that if there is a person who in the past purchased video works performed by artist A and video works performed by artist B, and if there is another purchaser or prospective purchaser who selects video works performed by artist A, there is a comparatively high probability that the video works performed by artist B will actually appeal to that person even assuming that he is unaware of the existence of video works performed by artist B.

Thus, the present invention, has a purchase record storage mechanism which associates and stores information on 2 or more products that a purchaser has purchased in the past, and searches information on other products associated with information on a product that a purchaser or prospective purchaser has selected on this occasion and offers the information on other products obtained by this search to a purchaser or prospective purchaser on this occasion.

Here it is desirable that “product” have characteristics that can be searched with a model or artist as a key. For example, video tapes which tape a motion picture in which a given performer appeared and DVD which recorded the previously noted motion picture or clothes and accessories etc. that were introduced and made famous by a certain model having worn them frequently in magazines.

In addition, “products” are not limited to tangible items. For example, this may also apply to such things as data and computer programs etc. for reproducing information etc. distributed or sent via telecommunications lines.

“Product information” or “information on products” must be the name or designation of a model or artist/performer having an association with the product but it may also be information other than the previously noted name or designation and may include things which express characteristics of a given product.

### BRIEF DESCRIPTION OF THE DRAWING

FIG. 1 is an over-all block diagram of the product offering system which is an embodiment of the present invention.

FIG. 2 is a drawing of the data structure of the product information storage mechanism shown in FIG. 1.

FIG. 3 is a drawing of the data structure of the purchase record storage mechanism shown in FIG. 1.

FIG. 4 is a flow chart of the purchase processing which the control mechanism of the server system executes in FIG. 1.

FIG. 5 is a flow chart of the product offering processing which the control mechanism of the server system executes in FIG. 1.

### DETAILED DESCRIPTION OF THE INVENTION

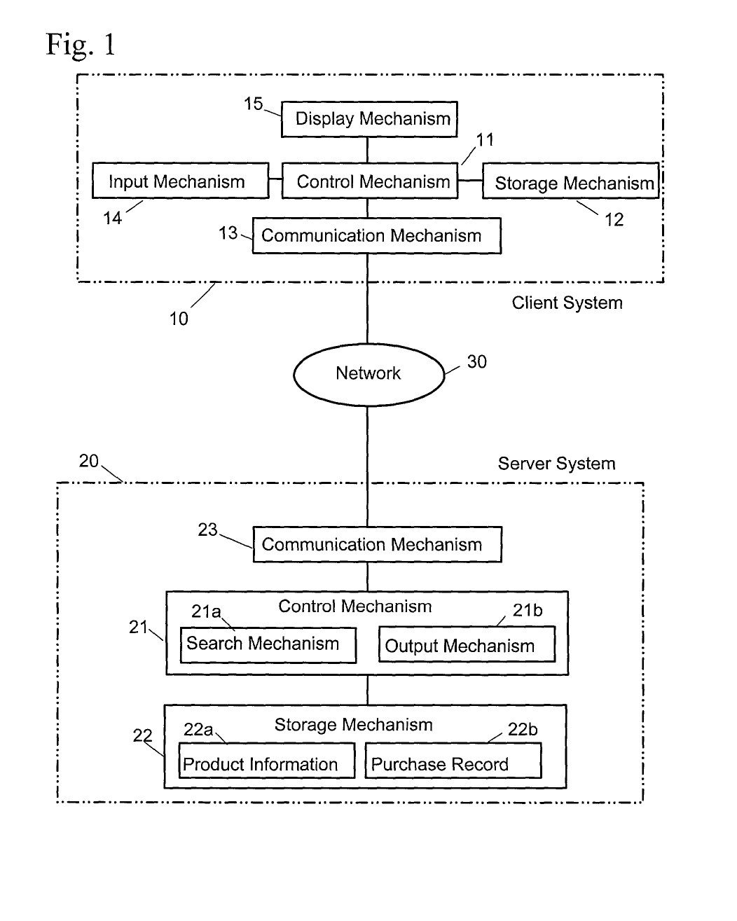

FIG. 1 is an over-all block diagram of the product offering system of this embodiment. This system is configured by a client system 10 in which a system user inputs and views information and a server system 20 which sends product information to client systems and makes offers connected by a computer network 30 such as the Internet.

Client system 10 is furnished with a control mechanism 11 containing a CPU etc., storage mechanisms 12 such as RAM, ROM and HDD (Hard disk drive), a communication mechanism 13 which sends data to and receives data from network 30, input mechanisms 14 such as keyboards and mice etc. and a display mechanism 15 such as a computer display etc.

Server system 20, on the other hand, is furnished with control mechanism 21 containing a CPU etc., storage mechanisms 22 such as RAM, ROM and HDD (Hard disk drive), and a communication mechanism 23 which sends data to and receives data from network 30.

Of these, storage mechanism 22 is furnished as a storage area with product information storage mechanism 22a which stores information for each product and purchase record storage mechanism 22b which stores information with respect to 2 or more products that a purchaser has purchased in the past.

Similarly, control mechanism 21 is furnished with searching mechanism 21a which searches purchase record storage mechanism 22b for other product information related to information on a product that a purchaser or a prospective purchaser has selected and an output mechanism 21b which will offer to a purchaser or a prospective purchaser on this occasion information on other products obtained with this searching mechanism 21a.

In this embodiment, search mechanism 21a and output mechanism 21b are realized by control mechanism 21 executing product offering programs stored in storage mechanism 22.

The previously noted product offering programs may contain a process which executes processing which sends other product information obtained from the previously noted search mechanism 21a to output mechanism 21b as electronic mail for offering products.

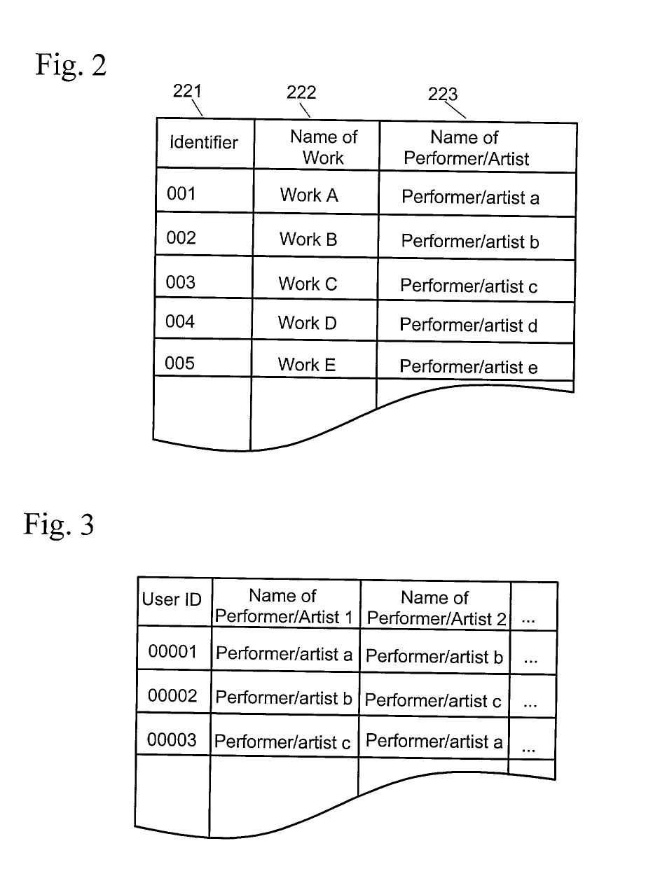

FIG. 2 is a drawing of the structure of the data stored in product information storage mechanism 22a. Identifiers 221 are assigned for each product and in addition, product information 222 is also attached for each product. In the present embodiment, the product, for example, is assumed to be data for reproducing a work of art which is a visual image which is sent via a recording medium called a DVD which has recorded a visual image of a work of art or via telecommunications lines. The name of the work of art and the names of the persons who performed the work of art are appended as product information.

FIG. 3 is a drawing of the structure of the data stored in purchase record information mechanism 22b. This is such that information on numerous products that a user has purchased in the past will be stored in association with a user ID that is assigned in advance to users of this system.

Next we shall explain the operation of this system.

### Purchase Processing

Control mechanism 21 in server system 20, reads specified product information (product identifiers, names of work of art/performance, name of artist/performers) from product information storage mechanism 22a in response to a request from client system 10 and sends it to client system 10 via communications mechanism 23.

Control mechanism 11 in client system 10, receives product information sent from server system 20 via communication mechanism 13 and displays it on display mechanism 15. The user, enters, at least, selection of a product displayed on display mechanism 15 and a request to purchase that product from input mechanism 14. Control mechanism 11 which receives this input sends the information on the product selected (product identifier) and a purchase request to server system 20 via communications mechanism 13. In addition, control mechanism 11, sends information needed for completing this user's transaction, including the user's ID to server system 20.

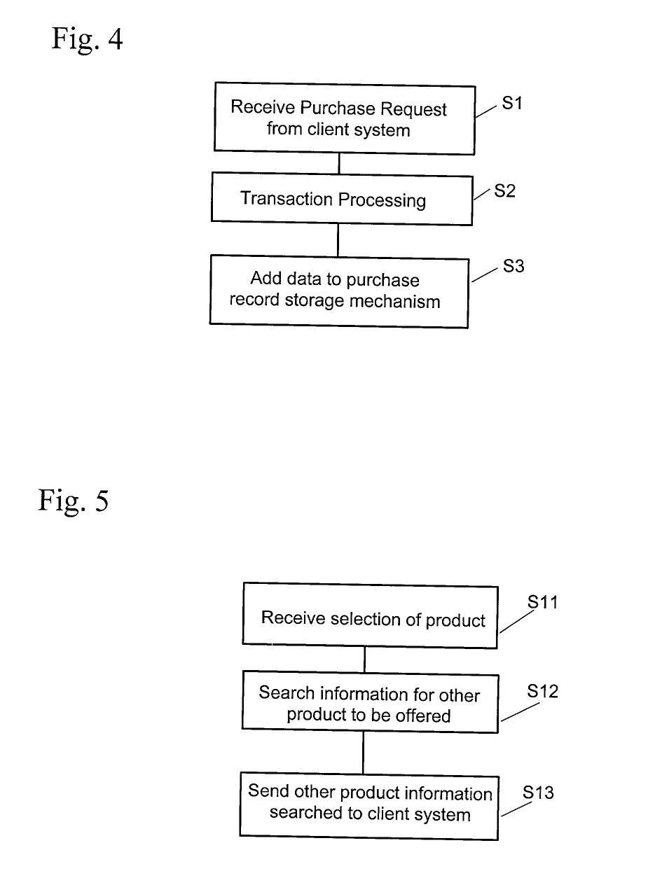

Control mechanism 21 in server system 20 momentarily holds the product information (product identifier) purchase request and information needed for the transaction received from client system 10 via communications mechanism 23 in storage mechanism 22 (S1 of FIG. 4). Next, control mechanism 21 executes specified transaction processing (S2) based on information necessary for completing this user's transaction. Then, control mechanism 21 searches product information storage mechanism 22a for information on the product purchased (name of artist/performer) with the product identifier as the key and updates it to the purchase record storage mechanism 22b in connection with the user ID of the user who made this purchase (S3). In this embodiment, when a user purchases videos created by 2 or more different artists/performers at the same time or at different times both artist/performers will be associated with the user's ID.

### Product Offering Processing

Control mechanism 21 in server system 20 reads specified product information (product identifier, name of work, name of artist/performer) from product information storage mechanism 22a in response to a request of client system 10 and sends it to client system 10 via communications mechanism 23.

Control mechanism 11 in client system 10, receives product information sent from server system 20 via communications mechanism 13 and displays it on display mechanism 15. A user, enters at least selection of a product displayed on display mechanism 15 from input mechanism 14. Control mechanism 11 which receives this input sends the information on the product selected (product identifier) to server system 20 via communications mechanism 13.

Control mechanism 21 in server system 10 receives product information (product identifier) sent from client system 20 via communications mechanism 23 and holds it temporarily in storage mechanism 22 (S11 of FIG. 5). Then control mechanism 21 starts search mechanism 21a, searches product information storage mechanism for product information selected by the user (artists/performers name) with the product identifier as a key and also searches purchase record storage mechanism 22b for records which have the same artist/performers name as the artist/performers name which is being searched. Then control mechanism 21 extracts other artist/performers names associated with the previously noted artist/performers name from the records searched. Next, control mechanism 21 searches product information storage mechanism 22a with the other artist/performers names which were extracted as keys, and extracts that artist/performers product information (product identifier, name of work) (S12). Then control mechanism 21 starts output mechanism 21b and sends the other product information that has just now been searched (product identifier, name of work, artist/performers name) to the client system via communications mechanism 23 (S13).

Control system 11 in client system 10 receives other product information sent from server system 20 via communications mechanism 13 and displays it on display mechanism 15. The user, by at least selecting the product displayed on display mechanism 15 and entering a purchase request for that product from input mechanism 14 can execute the previously noted purchase processing.

In offering products suiting the preferences of a user with the previously explained embodiment, the user need not enter data expressing preferences and personal data etc. and is freed from the bother of entering these things since they are not required. In addition, this eliminates the concern that such personal data will fall into the hands of unauthorized parties.

This invention is not limited to the embodiment described above. When searching for other product information from a purchase record storage mechanism, one or more other items of other product information (in this embodiment the names of other artists/performers) associated with the product information which is the key (in this embodiment the artist/performer of the work selected by the user) may be searched from things that are frequently recorded in the purchase record storage mechanism (in the present embodiment, works performed by numerous other performers in the past that many users have purchased in addition to the work by this performer). This improves the probability that a product can be offered that is most suitable to a user's preferences.

In addition, the preferences of others in the past for a given product can tend to reflect the preferences of subsequent users and preferably the product will be one that can be searched with a name of a model or performer. For example, video tapes and DVD etc. which are recordings of a collection of television shows in which a given performer appeared. Or clothes and accessories etc. that were introduced and made famous by a certain model having worn them frequently in magazines.

Product information stored in a purchase record storage mechanism, if it contains the name of the model or performer associated with that product may also contain other information which expresses the characteristics of that product.

In addition, while the product offering system of the previously noted embodiment was illustrated in the form of a network system, the configuration is not restricted to this. That is to say, if it is furnished with a purchase record storage mechanism which stores product information for 2 or more products that a purchaser has purchased in the past, a searching mechanism which searches information on other products associated with product information of one product that the purchaser or prospective purchaser has selected on this occasion from the previously noted purchase record storage mechanism and an output mechanism which offers other product information searched by the search mechanism to the purchaser or prospective purchase, a stand alone system is sufficient. The configuration of a network system is also not restricted to the previously noted embodiment.

### Effect of the Invention

The present invention, since it is configured and functions as previously noted, to offer products suiting the preferences of a user with the previously explained embodiment, the user need not enter data expressing preferences and personal data etc. and is freed from the bother of entering these things since they are not required. In addition, this eliminates the concern that such personal data will fall into the hands of unauthorized parties. Thus, it can provide a superior method and system of offering products as well as media which has recorded product offering programs.

Table of Reference Numbers

| | | | |
|---|---|---|---|
| 10 | Client system | 15 | Display mechanism |
| 11 | Control mechanism | 20 | Server system |
| 12 | Storage mechanism | 21 | Control mechanism |
| 13 | Communication mechanism | 22 | Storage mechanism |
| 14 | Input mechanism 30 | 23 | Communication mechanism |

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of offering products to a prospective purchaser comprising:
a) storing, in a purchase record storage mechanism, information regarding two or more purchases by each of a plurality of actual purchasers;
b) obtaining indicia of a product selected by the prospective purchaser;
c) finding in the purchase record storage mechanism indicia of one or more actual purchasers who have purchased a product that corresponds, by name or designation of a model or artist, to the selected product; and
d) offering to the prospective purchaser other products, wherein the other products correspond, by name or designation of a model or artist, to products purchased by the one or more actual purchasers found in the previous step.

2. An apparatus for offering products to a prospective purchaser comprising:
a) means for storing, in a purchase record storage mechanism, information regarding two or more purchases by each of a plurality of actual purchasers;
b) means for obtaining indicia of a product selected by the prospective purchaser;
c) means for finding in the purchase record storage mechanism indicia of one or more actual purchasers who have purchased a product that corresponds, by name or designation of a model or artist, to the selected product; and
d) means for offering to the prospective purchaser other products, wherein the other products correspond, by name or designation of a model or artist, to products purchased by the one or more actual purchasers found by the finding means.

3. An apparatus for offering products to a prospective purchaser comprising one or more computer readable storage media having recorded thereon a computer executable program that, in a system having a purchase record storage mechanism which stores information regarding two or more purchases by each of a plurality of actual purchasers, offers products to a prospective purchaser, wherein the program:
a) obtains indicia of a product selected by the prospective purchaser;
b) finds in the purchase record storage mechanism indicia of one or more actual purchasers who have purchased a product that corresponds, by name or designation of a model or artist, to the selected product; and
c) offers to the prospective purchaser other products, wherein the other products correspond, by name or designation of a model or artist, to products purchased by the one or more actual purchasers found.
